(19) United States
(12) Patent Application Publication
(10) Pub. No.: US 2024/0152103 A1
(43) Pub. Date: May 9, 2024

(54) SYNCHRONIZING NETWORK REFERENCE TIME AMONG POWER LINE COMPONENTS

(71) Applicant: X Development LLC, Mountain View, CA (US)

(72) Inventors: Rui Yao, San Jose, CA (US); Xinyue Li, San Mateo, CA (US); Leo Francis Casey, San Francisco, CA (US); Mike Miao He, Mountain View, CA (US)

(21) Appl. No.: 17/981,117

(22) Filed: Nov. 4, 2022

(51) Int. Cl. G05B 19/042

(52) U.S. Cl. CPC G05B 19/042; G05B 2219/2639

(57) ABSTRACT

Methods, systems, and apparatus, including computer programs encoded on a computer storage medium, for performing an electric grid time synchronization process. The process can include: receiving, from a GPS transceiver of a first device coupled to an electric power grid, data including a GPS time reference; formatting the GPS time reference into a data packet, where the data packet has a particular format compatible with power line communication; and broadcasting, by the first device and using power line communications, the data packet to a plurality of electric grid components.

### TECHNICAL FIELD

The present specification relates to electrical power grids, and specifically to time synchronization of sensors on the electrical power grids.

### BACKGROUND

Electrical power grids transmit electrical power to loads such as residential and commercial buildings. Electrical grid situational awareness and modeling relies on networks of sensors over the grid. Sensors should have accurate reference times associated with measurements that the sensors perform in order to accurately evaluate and correlate measurement data grid wide. For example, calculating of accurate phase differences requires accurate timing between voltage and current measurements. While some grid sensors (e.g., phasor-measurement units) do maintain very accurate timing references, many other sensors do not.

### SUMMARY

Some electric grid operations, measurements, or both rely on high quality sensor data, such as voltage, current, phasor angles, and the time of measurement. Some sensors, such as phasor-measurement units (PMU), provide accurate enough time information to determine phasor angles. These types of sensors, however, are expensive, making implementation throughout the electric grid costly. Many other types of sensors are already present in the electric grid, but they use less accurate time reference sources, e.g., internet-based time calibration schemes that can be affected by network latency at the millisecond level.

The present disclosure is related to a process for synchronizing highly accurate time reference signals with multiple components (e.g., sensors) on an electric grid. For example, an electric grid component that has the capability to synchronize with a highly accurate reference time is configured to broadcast timing reference messages to other components coupled to the electric grid through power line communication (PLC) communication network technology. For instance, a first sensor that has a GPS transceiver is configured to periodically broadcast a GPS reference time throughout the electric grid network using PLC communications. Other sensors that are not GPS capable can leverage the GPS capabilities of the first sensor by synchronizing their internal clocks to the GPS reference times broadcast by the first sensor.

PLC operates by adding modulated signals to existing public and private wiring systems. PLC avoids network latency by transmitting electromagnetic signals without buffers and delays. In areas where PLC is available, one or more GPS antennas can broadcast accurate time reference signals and encode the signals into the electric grid. By updating the firmware of sensors with less accurate time reference sources to be able to decode signals received from PLC for clock calibration, the sensors can determine a more accurate time reference, e.g., with error less than a millisecond.

In some implementations, a central device can receive data including a time reference from at least one GPS antenna. The central device can format the data into a data packet such that sensors connected to the electric grid can receive the data. After the central device transmits the data packet, the sensors can decode the signals for clock calibration. The GPS antenna and the sensors can follow a protocol for encoding and decoding signals based on PLC.

In general, innovative aspects of the subject matter described in this specification can be embodied in methods that include the actions of receiving, from one or more GPS transceiver of a first device coupled to an electric power grid, data including a GPS time reference; formatting the GPS time reference into a data packet, where the data packet has a particular format compatible with power line communication; and broadcasting, by the first device and using power line communications, the data packet to multiple electric grid components. Other implementations of this aspect include corresponding systems, apparatus, and computer programs, configured to perform the actions of the methods, encoded on computer storage devices.

In another general aspect, innovative aspects of the subject matter described in this specification can be embodied in methods that include actions of: receiving, by an electric power grid sensor, a data packet over a power line communication network, the data packet including a GPS time reference value; processing, by the electric power grid sensor, the data packet to extract the GPS time reference value; updating a clock of the electric power grid sensor using the extracted GPS time reference value. Other implementations of this aspect include corresponding systems, apparatus, and computer programs, configured to perform the actions of the methods, encoded on computer storage devices.

These and other implementations can each optionally include one or more of the following features.

In some implementations, the method can further include converting the GPS time reference to a format compatible with the multiple electric grid components.

In some implementations, the data packet includes a phasor angle, a date time group, global positioning system timing data, error correction coding, or a combination thereof.

In some implementations, the data packet is encrypted.

In some implementations, a format of the data is different from the particular format compatible with power line communication.

In some implementations, at least one of the multiple electric grid components is not GPS capable.

In some implementations, broadcasting the data packet can include broadcasting data packets in intervals of 60 seconds or less.

In some implementations, the multiple electric grid components are each connected to a common feeder.

In some implementations, the first device is a phasor measurement unit, and the multiple electric grid components include one or more of voltage sensors, power sensors, or current sensors.

In some implementations, updating the clock of the electric power grid sensor causes synchronization between the electric power grid sensor and at least one other electric power grid sensor.

In some implementations, the synchronization is accurate within a millisecond.

Particular implementations of the subject matter described in this specification can be implemented so as to realize one or more of the following advantages. Implementations may improve the accuracy of electric grid sensors with lower quality time reference sources without having to make hardware changes to the sensors (e.g., adding GPS transceivers). Electric grid monitoring and modeling can be performed more accurately when an increased amount of measurement data is paired with more accurate time references.

The details of one or more implementations of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 illustrates an example of an electric grid sensor system for time synchronization between sensors on an electrical power grid.

FIG. 2 illustrates an example process of a sensor formatting reference time data for transmission over a power line communication network.

FIG. 3 shows an example of a process for broadcasting time reference values throughout an electrical power grid.

FIG. 4 shows an example of a process for time synchronization between sensors on an electrical power grid.

### DETAILED DESCRIPTION

In general, simulations of the electrical power grid can incorporate measurements of current, voltage, phasor angle, and time taken by sensors on the electrical power grid. Some sensors on the electrical power grid can maintain a highly accurate reference time, while others are not equipped to do so. The concepts disclosed herein can allow time synchronization between sensors of different quality.

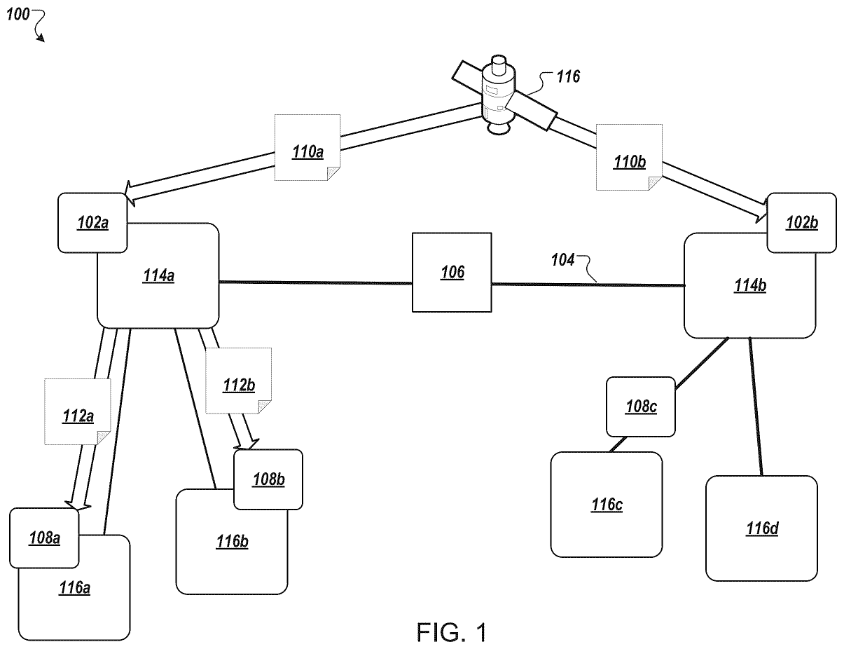

FIG. 1 shows an example of an electric grid system 100. In some implementations, the electric grid system 100 represents a common region, city, or other types of grid boundaries separating parts of the electrical power grid. Transmission lines 104 connect a power source 106, e.g., a power plant, to substations 114a and 114b and connect substations 114a and 114b to their respective loads 116a, 116b, 116c, in 116d. Electrical grid components, such as sensors, can be distributed throughout the electric grid system 100. Sensors 102a, 102b, 108a, 108b, and 108c, can measure electrical properties of components of the electric grid system 100. For example, sensors 102a and 102b are electrically connected to grid components at substations 114a and 114b, respectively. Sensors 108a and 108b are electrically connected to loads 116a and 116b (or to power lines or transformers that supply loads 116a and 116b), respectively. For example, load 116a can be a home, and sensor 108a can be a smart meter measuring the electrical properties of the home. As another example, sensor 108c can measure electrical properties at a transformer along the transmission line 104 between substation 114b and load 116c.

Sensors 102a-b and 108a-d can be voltage sensors, power sensors, current sensors, or a combination thereof. Sensors 102a and 102b have highly accurate reference time sources and/or the capability to synchronize timing with a highly accurate time reference (e.g., a GPS satellite). For example, sensors 102a and 102b can be phase measurement units and synchronize with high-quality, GPS temporal measurements. Sensors 102a and 102b maintain more accurate time references compared to sensors 108a-d. For instance, sensors 102a and 102b can periodically calibrate (or synchronize) their respective internal reference clocks with GPS timing data. In some implementations, sensors 108a-d are not GPS capable, and instead rely on less accurate methods for maintaining reference times, e.g., internet-based time calibration, which can measure voltage, current, and the time of measurement.

Sensors 102a and 102b can be equipped to receive GPS signals 110a and 110b, respectively, sent from a GPS transceiver 116. The GPS signals 110a and 110b can include, but are not limited to, data such as highly accurate, GPS time references and GPS timing data.

Sensors 102a and 102b can format the data in the GPS signals 110a and 110b into a format compatible with the clocking systems or circuits of sensors 108a, 108b, and/or 108c. For example, sensors 102a/102b can reformat the GPS timing signals into a date time group, phasor angles, or other time format. The data packet can be compatible with power line communication (PLC) or power line telecommunication (PLT). Communication over the PLC network can include adding modulated signals to preexisting public and private portions of the electrical power grid. Sensor 102a can broadcast the data packets 112a and 112b to sensors 108a and 108b, respectively.

Sensors 108a and 108b receive the data packets 112a and 112b, respectively, over the PLC network. Sensors 108a and 108b can process the data packet to extract the GPS time reference value. In some implementations, sensors that are not GPS capable, e.g., sensors 108a and 108b, can be updated with software, firmware, or both with instructions for extracting a GPS time reference in the data packet 112a or 112b. In some implementations, the content of data packets 112a or 112b can include, but is not limited to, phasor angles, date time group, GPS timing data, or a combination thereof.

Sensors 108a and 108b can update their respective clocks using the extracted GPS time reference value. After sensors 108a and 108b update, sensors 102a-b and sensors 108a-b are synchronized in time.

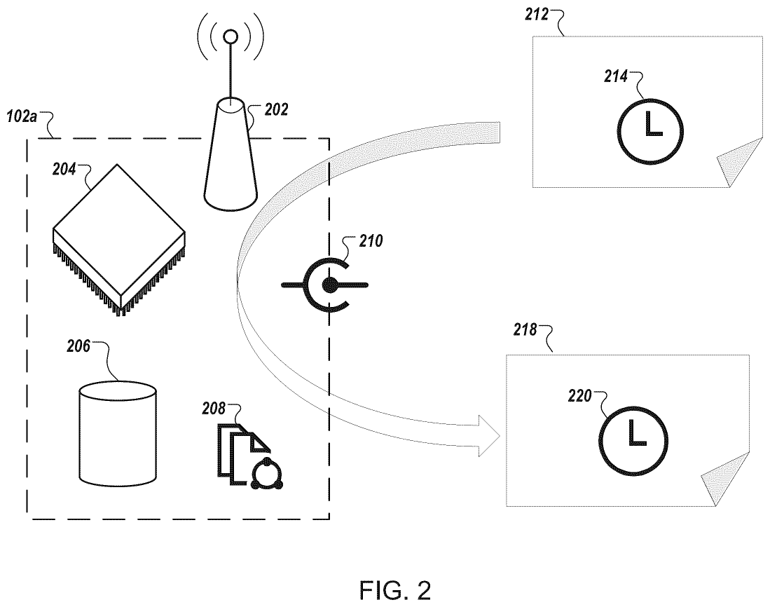

In some implementations, before broadcasting the data packet, a GPS capable sensor can reformat signals received from a GPS transceiver. For example, with reference to FIG. 2, the sensor 102a can receive GPS data 212 and format GPS data 212 to a data packet 218. The sensor 102a can include a GPS interface 202 (e.g., a GPS transceiver), allowing the sensor 102a to transmit and receive GPS signals. The sensor 102a can include a PLC interface 210, allowing the sensor 102a to transmit and receive power line communications. The sensor 102a can include a processor 204 (e.g., one or more microprocessors or microcontrollers), memory 206 (e.g., instruction registers), and firmware 208, which can configure the sensor 102a to format incoming data into data packets with a PLC compatible format.

Formatting the incoming data into data packets can include converting the GPS time reference to a time reference readable by non-GPS capable electrical grid components. For example, sensor 102a can receive, via the PLC interface 210, data 212, which includes a GPS time reference 214 and has a first format. The sensor 102a can then add the reformatted timing data to a data packet 218 for transmission over a PLC network. The data packet 218 can include a general time reference 220 and a second format, both of which are compatible with non-GPS capable electrical grid components.

In some implementations, formatting the data 212 into the data packet 218 can include using firmware 208 to extract information, such as the data type of data 212 and the GPS time reference 214 from data 212. The sensor 102a can store the extracted information in memory 206.

In some implementations, encapsulating the data 212 into the data packet 218 can include forming one or more empty data packets. The processor 204 within the sensor 102a can add header information, such as the source IP address, the destination IP address, a sequence number for each of the one or more data packets, the type of service for protocol, and other types of data, e.g., the format of the data packet. In some implementations, the source IP address can be the address of the GPS capable sensor on the PLC network. In some implementations, the destination IP address can be the network address of at least a portion of sensors for general electrical grid components with clocks. The processor 204 can add the payload, e.g., the timing information, to each of the one or more data packets.

In some implementations, a sequence of data packets can each contain a portion of one or more GPS timing references. In some implementations, the sequence number of the one or more data packets can correspond to a chronological order of temporal measurements. For example, the sensor 102a can broadcast the sequence of data packets at regular intervals, such that the recipients of the data packets can determine whether or not their clocks have drifted by comparing the multiple times at which the data packet arrives and the timestamps within the data packet.

In some implementations, formatting the data packets 218 can enhance data security. For example, the instructions for processing the data 212 can include encrypting the data contained in the data packets, e.g., applying a symmetric or asymmetric encryption process.

In some implementations, broadcasting the data packet 218 can include placing the data packet in an output buffer of the PLC interface 210. The PLC interface 210 and transmit the data packet 218 via the PLC network. For example, the sensor 102a can transmit the data packets to sensors 108a and 108b. In some limitations, sensor 102a can receive, via the PLC interface 210, signals from other PLC compatible devices on the grid, indicating a request for data packet related to time synchronization.

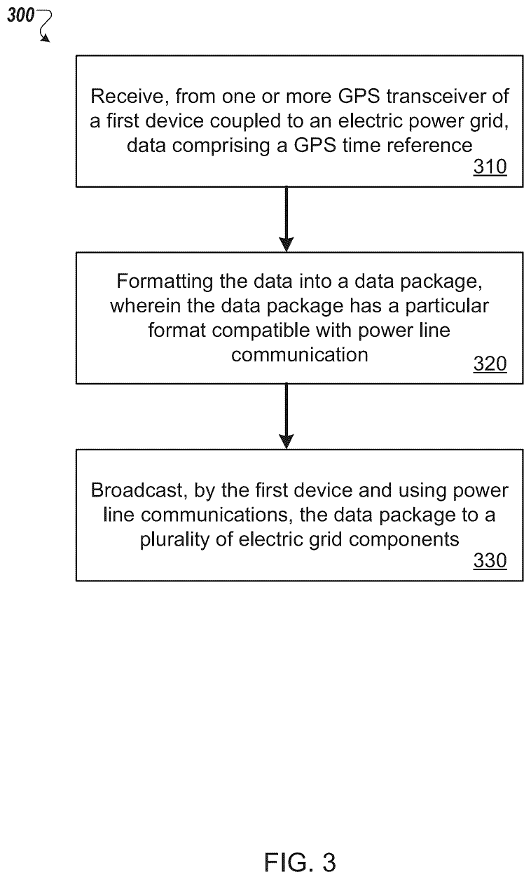

FIG. 3 is a flow diagram of a process 300 for broadcasting time reference values throughout an electrical power grid. For example, the process 300 can be performed by an electrical grid device, such as sensors 102a and 102b from the electric grid system 100.

A first device coupled to the electric power grid, such as sensor 102a-b, can receive a GPS time reference from a GPS transceiver 116 (310). In some implementations, the first device receives multiple messages from GPS transceivers, each with their own respective GPS time reference. In some implementations, the format of the data is not compatible with PLC.

The first device can format the data into a data packet (320). For example, a sensor can format the GPS time reference data into data packet 218, such that the data packet has a particular format compatible with power line communication. In some implementations, the first device performs the formatting by using software, firmware 208, or both, including instructions on how to format the data. For example, the format can correspond to lower-level data packets, e.g., data-link layers. In some implementations, the data packet is encrypted. In some implementations, the first device adds error correction coding to the data packet.

The first device can broadcast the data packet to other components on the electrical power grid (330). For example, a sensor can broadcast the data packet to other sensors on the electric power grid using a power line communication network.

In some implementations, process 300 repeats multiple times, with the broadcasting of the data packets occurring in intervals. For example, the first device can generate and broadcast clock synchronization data packets at intervals ranging between several hours to several, or less.

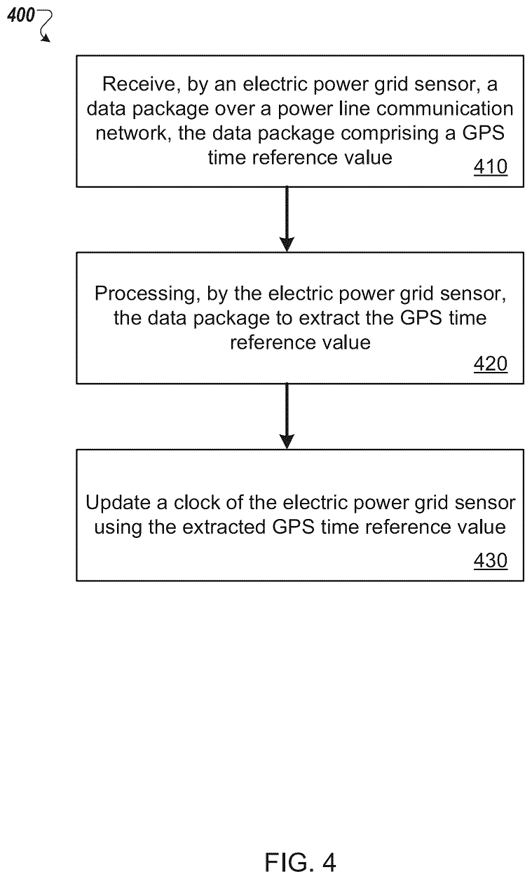

FIG. 4 is a flow diagram of a process 400 for time synchronization between sensors on the electrical power grid. For example, the process 400 can be performed by sensors 108a-d from the electric grid system 100.

An electric power grid sensor, such as any one of sensors 108a-d, can receive a data packet, e.g., data packet 112a or 112b, over a power line communication network. The data packet can include a GPS time reference value. (410). In some implementations, the electric power grid sensor is not GPS capable.

The electric power grid sensor can process the data packet to extract the GPS time reference value (420). In some implementations, the electric power grid sensor can be updated with firmware that includes instructions for how to identify, process, or both the data packet for extraction of the GPS time reference value.

The electric power grid sensor can update its clock using the extracted GPS time reference value (430). In some implementations updating the clock of the electric power grid can include adding time differential, which can be either positive or negative, to the time according to the electric power grid sensor. When multiple GPS transceivers are broadcasting data including GPS time references, the electric power grid can update its clock according to a function of the multiple extracted GPS time reference values.

The extracted GPS time reference value can agree with the time reference value of the device that sent the data packet. The device that sent the data packet can send data packets to multiple electric power grid sensors. Consequently, updating the clock of the electric power grid sensor can cause synchronization between the electric power grid sensor in the device that sent the data packet, e.g., 102a or 102b, and other electric power grid sensors that received data packets with the same GPS reference value, e.g., 108a-d. In some implementations, the time synchronization is accurate within a millisecond.

In some implementations, the process 300 is followed by the process 400, which can allow time synchronization between the device and the electric power grid sensor, among other components in the electrical power grid. For example, a sensor attached to a centralized transmitter with GPS signal can broadcast data including time references to other sensors, which will in response update their clocks.

In some implementations, data collected by sensors 102a-b and 108a-d can be used as input data for electrical power grid simulations. The quality of electrical power grid simulations can suffer when sensors that are not synchronized in time collect the input data. For example, simulation engines can compute results that have contradictory results if the input data, e.g., data collected by non-synchronized sensors, is out of sync. For example, if a first sensor measures a voltage signal, e.g., a sine wave with a phase of (I), at a first time and a second sensor measures the voltage signal at a second time after it has traveled a certain distance, the measurement of second sensor might indicate a phase other than (I) if the clocks of each sensor are not in sync.

The simulations can be based on, for example, root-mean-square (RMS), power flow, positive sequence, and/or time series, dynamic or transient analysis. The amount of data processed during each simulation can depend on the size and framework of the distribution feeder that is being evaluated. The simulation can analyze predicted effects for all connections to the affected distribution feeder and all components of the affected distribution feeder. Thus, the complexity of simulations can vary depending on construction of the distribution feeder.

Simulations can output analysis of the expected operation of the power grid when empirical historical data is available. The empirical historical data can include historical electrical grid characteristics based on, for example, measurements, calculations, estimates, and interpolations. The characteristics can include, for example, load, voltage, current, power factor, and the time of measurement. The empirical historical data can represent power grid operation of multiple interconnected components within a designated geographical area. The empirical historical data can represent average electrical grid operating characteristics over a period of time, e.g., multiple weeks, months, or years.

This disclosure generally describes computer-implemented methods, software, and systems for electrical power grid visualization. A computing system can receive various electrical power grid data from multiple sources. Power grid data can include different temporal and spatially dependent characteristics of a power grid. The characteristics can include, for example, power flow, voltage, power factor, feeder utilization, and transformer utilization. These characteristics can be coupled; for example, some characteristics may influence others and/or their temporal and spatial dependence may be related.

Data sources can include satellites, aerial image databases, publicly available government power grid databases, and utility provider databases. The sources can also include sensors installed within the electrical grid by the grid operator or by others, e.g., power meters, current meters, voltage meters, or other devices with sensing capabilities that are connected to the power grid. Data sources can include databases and sensors for both high voltage transmission and medium voltage distribution and low voltage utilization systems.

The data can include, but is not limited to, map data, transformer locations and capacities, feeder locations and capacities, load locations, or a combination thereof. The data can also include measured data from various points of the electrical grid, e.g., voltage, power, current, power factor, phase, and phase balance between lines. In some examples, the data can include historical measured power grid data. In some examples, the data can include real-time measured power grid data. In some examples, the data can include simulated data. In some examples, the data can include a combination of measured and simulated data.

Implementations of the subject matter and the functional operations described in this specification can be implemented in digital electronic circuitry, in tangibly-implemented computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including, by way of example, a programmable processor, a computer, or multiple processors or computers. The apparatus can also be or further include special purpose logic circuitry, e.g., a central processing unit (CPU), a FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application-specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any system or on the scope of what may be claimed, but rather as descriptions of features that may be specific to particular implementations of particular systems. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of sub-combinations.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be helpful. Moreover, the separation of various system modules and components in the implementations described above should not be understood as requiring such separation in all implementations.

Particular implementations of the subject matter have been described. Other implementations, alterations, and permutations of the described implementations are within the scope of the following claims as will be apparent to those skilled in the art.

For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. An electric grid time synchronization method comprising:
receiving, from one or more GPS transceiver of a first device coupled to an electric power grid, data comprising a GPS time reference;
formatting the GPS time reference into a data packet, where the data packet has a particular format compatible with power line communication; and
broadcasting, by the first device and using power line communications, the data packet to a plurality of electric grid components.

2. The method of claim 1, further comprising converting the GPS time reference to a format compatible with the plurality of electric grid components.

3. The method of claim 2, where the data packet comprises a phasor angle.

4. The method of claim 2, where the data packet comprises a date time group.

5. The method of claim 2, where the data packet comprises global positioning system timing data.

6. The method of claim 2, where a format of the data is different from the particular format compatible with power line communication.

7. The method of claim 1, where at least one of the plurality of electric grid components is not GPS capable.

8. The method of claim 1, where broadcasting the data packet comprises broadcasting data packets in intervals of 60 seconds or less.

9. The method of claim 1, where the plurality of electric grid components are each connected to a common feeder.

10. The method of claim 1, where the data packet is encrypted.

11. The method of claim 1, where the data packet comprises error correction coding.

12. The method of claim 1, where the first device is a phasor measurement unit, and where the plurality of electric grid components comprise one or more of voltage sensors, power sensors, or current sensors.

13. An electric grid time synchronization method comprising:
receiving, by an electric power grid sensor, a data packet over a power line communication network, the data packet comprising a GPS time reference value;
processing, by the electric power grid sensor, the data packet to extract the GPS time reference value; and
updating a clock of the electric power grid sensor using the extracted GPS time reference value.

14. The method of claim 13, where the data packet comprises a phasor angle.

15. The method of claim 13, where updating the clock of the electric power grid sensor causes synchronization between the electric power grid sensor and at least one other electric power grid sensor.

16. The method of claim 15, where the synchronization is accurate within a millisecond.

17. An electric grid sensor comprising:
one or more instruction registers comprising one or more instructions, stored thereon, for performing electric grid time synchronization;
a power line communication (PLC) interface;
a GPS transceiver; and
one or more processors in electrical communication with the GPS transceiver, the PLC interface, and the one or more instruction registers, the one or more processors configured to execute the one or more instructions to perform operations comprising:
receiving, from the GPS transceiver, data comprising a GPS time reference;
formatting the GPS time reference into a data packet, where the data packet has a particular format compatible with power line communication; and
broadcasting, using PLC interface, the data packet to a plurality of components coupled to an electric grid.

18. The sensor of claim 17, wherein the operations further comprise converting the GPS time reference to a format compatible with the plurality of electric grid components.

19. The sensor of claim 18, where a format of the data is different from the particular format compatible with power line communication.

20. The sensor of claim 1, where at least one of the plurality of electric grid components is not GPS capable.
